(19) United States
(12) Patent Application Publication
(10) Pub. No.: US 2002/0190438 A1
(43) Pub. Date: Dec. 19, 2002

(54) Process and kit for casting sand

(76) Inventor: Michael Landauer, Toronto (CA)

Correspondence Address: Mark B. Eisen, Dimock Stratton Clarizio, 20 Queen Street West, Suite 3202, Box 102, Toronto, ON, M5H 3R3, CA

(21) Appl. No.: 09/881,031

(22) Filed: Jun. 15, 2001

(51) Int. Cl. B29C 35/08

(52) U.S. Cl. 264/489; 264/490; 425/174.4

(57) ABSTRACT

There is provided a process and kit for casting sand that is safe and efficient for children to use in the home. The process involves the steps of mixing sand with a non-toxic binding resin to form a resin/sand mixture; casting the resin/sand mixture into a preferred form; heating the resin/sand mixture in a microwave oven until a sand casting is set; and, letting the sand casting cool.

### FIELD OF THE INVENTION

The invention relates to a process and kit for casting sand and in particular to a process and kit suitable and safe for use in the home.

### BACKGROUND OF THE INVENTION

The ability for young and old to cast and fix sand has been of growing interest since the early days of sand castling on the beach.

In the early 1980's, this interest led to the introduction of three techniques for fixing sand. The first technique provided a method for fixing sand in two dimensions by laying glue down on a surface and then spraying sand onto the glue. The second technique used a glass container with channels and passages to hold sand in three dimensions. The third technique brought sand castling on the beach to a performance art by applying a glue spray to the sand castle once it had been built to temporarily fix the sand. While each of these techniques provided methods for fixing sand, none can be used to permanently fix the sand in three dimensions.

Around the same time, a commercial process for casting sand was developed by the applicant in which a permanent sand casting could be created by mixing an epoxy or aromatic resin with sand and then applying the sand and resin mixture to a latex or silicon mold. This process was useful for casting sand on a commercial level. However, the process, and in particular the resin used, was not suitable or safe for use in an unventilated area or for use non-commercially.

Several attempts have been made in the prior art to introduce kits for casting sand that are safe for non-commercial use and for use by children.

In particular, U.S. Pat. No. 5,895,304 provides a kit for making temporary wet sand structures. The kit includes casting molds, support posts, support plates, and clips and allows for the formation of multi-tier wet sand structures.

U.S. Pat. No. 3,447,256 discloses a game in the form of a kit for creating temporary sand structures and designs. Sand designs are created by mixing an aqueous slurry of sand and water and depositing the slurry (with an eyedropper etc.) onto a high capillary bed (such as a bed of high capillary coloured sand) so that the moisture from the slurry is removed and the sand is deposited onto the bed in an ornamental pattern. The kit provides all components for making the sand designs, including, compartments for holding the base material, sand for making the slurry, mixing and dispensing means. The kit contemplates that the sand can be re-used again and again.

U.S. Pat. No. 2,451,711 discloses a device for sand modelling comprising a sand pail with a sand sifter, sand scoop, and sand molds located inside. To mold sand, the sand is placed in the pail first and then the molds and sand sifter are placed in the pail in an arrangement that facilitates molding by inverting the pail and sifting the sand into a mold of proper configuration using the molds.

None of these kits, however, can be used to permanently fix sand in three-dimension.

There therefore remains a need to provide a process for permanently casting sand in three dimensions, which is safe and easy to use in the home by young and old.

### SUMMARY OF THE INVENTION

The process and kit for casting sand, provided by the present invention, is a safe and easy means to permanently fix sand in three dimensions. According to one aspect of the invention, it provides a process for casting sand, said process comprising the steps of: mixing sand with a non-toxic binding resin to form a resin/sand mixture; casting the resin/sand mixture into a preferred form; heating the resin/sand mixture in a microwave oven until a sand casting is set; and, letting the sand casting cool.

In one embodiment of the invention, the resin/sand mixture is cast into a preferred form using a microwavable mold.

In a further embodiment of the invention, the process includes the further steps of carving the resin/sand mixture prior to heating and decorating the sand casting after cooling.

According to another aspect of the invention, it provides a kit for making a sand casting, said kit comprising: sand; a non-toxic binding resin; and a microwavable mold.

In a further embodiment of the invention, the kit includes carving tools and decorating tools.

The process and kit for casting sand of the present invention has many advantages. In particular, it incorporates the use of a non-toxic resin that can be safely heated in a conventional microwave oven, thereby allowing the process and kit to be used safely in the home and by children. The resin that is used is also a binding resin. It therefore creates a sand mixture that, when heated, leads to a permanently fixed three-dimensional sand structure. The process also includes the step of heating the sand casting in a microwave oven to make it set. Using a microwave oven provides the further advantage of ensuring complete and uniform drying of the sand casting and a strong and non-friable sand casting.

Various other advantages will be apparent to the person skilled in the art from the following description of the present invention read in conjunction with the accompanying drawings.

### BRIEF DESCRIPTION OF THE DRAWINGS

In drawings which illustrate by way of example only a preferred embodiment of the invention,

FIG. 1 is a schematic diagram of the process for casting sand.

FIG. 2 is a perspective view of a preferred embodiment of the sand casting kit.

### DETAILED DESCRIPTION OF THE PREFERRED EMBODIMENT

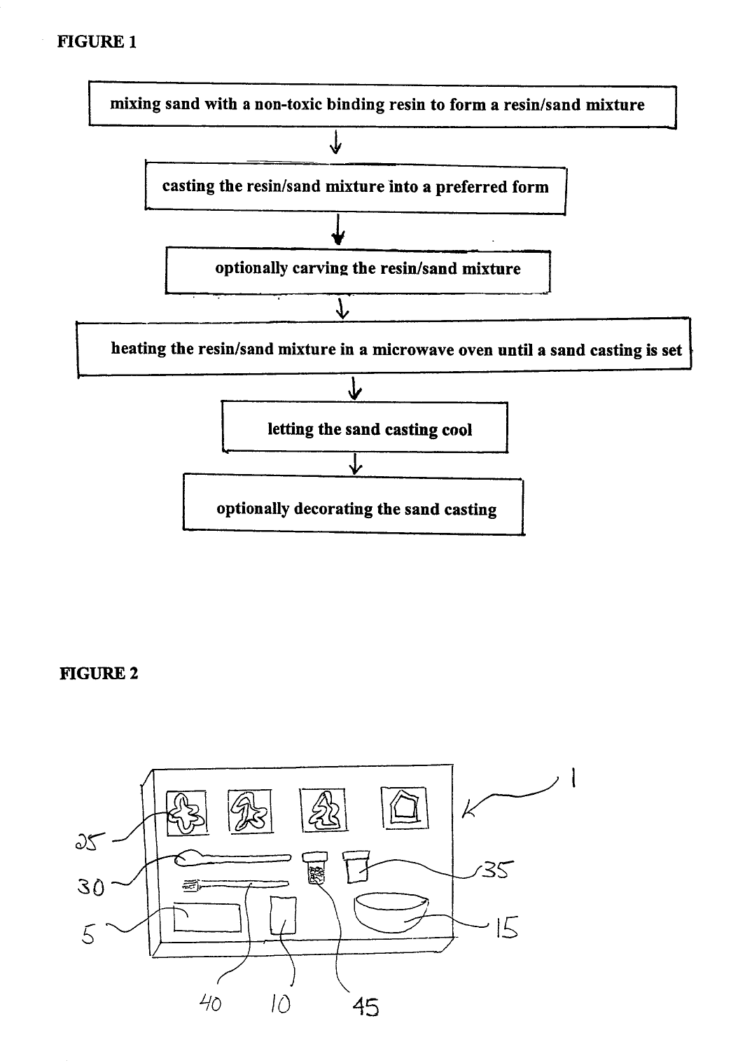

Referring to the flow chart provided by FIG. 1, the process for casting sand includes the following steps: mixing sand with a non-toxic binding resin to form a resin/sand mixture; casting the resin/sand mixture into a preferred form; heating the resin/sand mixture in a microwave oven until a sand casting is set; and, letting the sand casting cool.

The first part of the process for casting sand therefore involves mixing sand with a non-toxic binding resin to form a resin/sand mixture.

The resin may be any safe, non-toxic resin that bonds to the sand and sets the sand upon microwaving. Preferably, the resin comprises a poly (vinyl acetate), which does not release hazardous odours on microwaving and has improved binding capabilities on heating. One such poly (vinyl acetate) resin is sold commercially by Elmer's Products Inc. as ELMER'S® All Purpose Glue.

In a preferred embodiment, the resin and sand are mixed in ratios in the range of about 1:4 and 1:6, preferably about 1:5 parts resin to sand is used to form the resin/sand mixture. Increasing the ratio of resin to sand above 1:4 results in a mixture of sand and resin that is difficult to carve. Decreasing the ratio of resin to sand below 1:6 may result in a mixture of sand and resin that is weak and does not set well after heating. The ratio of about 1:5 is therefore preferred to ensure adequate durability and carving potential.

To avoid clumping and distortion, the sand and resin mixture should be mixed well before the resin/sand mixture is heated. In particular, the resin/sand mixture should be thoroughly mixed until the mixture has uniform consistency.

Once the resin/sand mixture is prepared, it is cast into a desired form. In a preferred embodiment, the resin/sand mixture is placed into a microwavable mold that is suitable for use in a microwave oven. It will be apparent to the person skilled in the art that any shape and size of mold can be used, so long as the mold is made from a microwavable material. The shape and size of the mold is chosen on the basis of the shape and size of the sand casting desired. In one example, a mixture of 30 mL resin and 135 mL sand produces a 4″×2″×0.5″ sand casting.

The sand casting is then heated in a microwave oven in order to permanently fix the sand casting into its desired form. In a preferred embodiment, the resin/sand mixture is heated in a typical household microwave oven for approximately 2 to 5 minutes on high heat, or until the sand casting sets. Most preferably, the resin/sand mixture is heated for 3 minutes on high heat. It will be apparent to the person skilled in the art, however, that the optimum time for heating is a function of the power of the microwave oven and the size of the sand casting.

After heating in the microwave oven is completed, the sand casting is removed from the microwave oven and allowed to cool. Preferably, the sand casting is left to stand for at least 1 minute or until the sand casting is suitably cooled for handling.

After cooling, the sand casting may be decorated by painting or drilling. The ratio of resin to sand should be decreased to about 1:4 if drilling is anticipated.

The sand casting may be carved before the heating step by placing a cutting mold into the resin/sand mixture. For defined shapes, a cookie cutter can be placed in the pre-microwaved, resin/sand mixture and then removed before heating so as to leave the outline of the desired shape in the resin/sand mixture.

After heating in the microwave oven, the sand casting can be removed from the mold and the excess sand can be removed easily with a conventional carving tool.

In order to carve the sand casting prior to heating, the resin/sand mixture must first be compounded with a wooden mallet or like device in order to strengthen the resin/sand mixture around the cutting site and avoid sand displacement during cutting. The carving tool should remain wet while carving in order to remove any residual resin/sand mixture that accumulates on the carving tool. Any type of carving tool may be used. Most preferably, a carving tool is chosen that makes clean cuts in the sand casting and that can be wet easily during use.

In order to create a shiny finish on the sand casting, the sand casting may be painted prior to or after heating with glitter glue. An example of glitter glue that can conveniently be used for this purpose is Crayola® Glitter Glue, which comes with an easy-to-use dispensing applicator.

Very elaborate sand castings can be created using the process provided by the present invention. In order to prepare a more detailed and elaborate sand casting, multi-part microwavable vacuum molds can be used. In some instances, when using a multi-part microwavable vacuum mold, additional heating or setting time may be required. Such molds are therefore preferably made of heat resistant plastic and are durable enough to resist any heat damage that might be caused by this additional heating time.

The use of a multi-part microwavable vacuum mold may also require extra effort when loading the resin/sand mixture into the mold to ensure that all areas of the mold are filled with the resin/sand mixture. The use of talcum powder may accordingly be required to ensure that the sand casting can be removed cleanly from all areas of the mold after heating.

While it is important that the resin is used in concentrated form in order to have optimal setting, using a diluted resin/sand mixture will improve the ease of pouring the mixture into a more complex multi-part mold. Such dilution should, however, not be used often as diluting the resin with water in a 1:1 ratio results in a sand casting that requires prolonged heating to set and therefore provides the risk that the microwavable mold may be melted, damaged, or cracked in the microwave oven during prolonged heating.

It will be apparent that the resin/sand mixture can be cast in several ways without deviating from the invention as claimed. In the preferred embodiment, a microwavable mold is used. However, in another embodiment, a rolling pin on a flat bed can be used with make-shift adjustable retainers to smooth and compress the resin/sand mixture for carving prior to heating.

The process for casting sand may be easily facilitated by providing the components for the process in a ready to use kit. As shown in FIG. 2, a preferred embodiment of the kit 1 includes a package of sand 5, a container of non-toxic binding resin 10, and a microwavable mold 15, together with instructions for preparing the sand casting. Optionally, there may be included carving tools, such as cookie-type cutters 25, and a carving knife 30, and decorating tools, such as paints 35, a paint bush 40, and glitter glue 45.

The instructions would provide information on the appropriate quantities of sand and resin to mix together, the length of mixing time, the appropriate time and duration of microwaving, and cooling time. Optionally, the instructions may also include information on how to carve, paint, and decorate the sand casting.

A second embodiment of the kit could include a rolling pin, microwavable flat bed and adjustable retainers instead of a microwavable mold.

Numerous other variations, examples and modifications will also be apparent to a person skilled in the art and should be considered as included in the invention where all such variations, examples and modifications fall within the scope of the appended claims.

We claim:

1. A process for casting sand, said process comprising the steps of:
(a) mixing sand with a non-toxic binding resin to form a resin/sand mixture;
(b) casting the resin/sand mixture into a preferred form;
(c) heating the resin/sand mixture in a microwave oven until a sand casting is set; and,
(d) letting the sand casting cool.

2. The process of claim 1, wherein the non-toxic binding resin comprises a poly (vinyl acetate).

3. The process of claim 2, wherein the step of casting the resin/sand mixture involves placing the resin/sand mixture into a microwavable mold.

4. The process of claim 2, wherein the resin/sand mixture is heated for about 2 to 5 minutes.

5. The process of claim 2, wherein the resin/sand mixture is heated for about 3 minutes.

6. The process of claim 2, wherein in step (a), the resin and sand are mixed in a ratio in the range of about 1:4 to 1:6.

7. The process of claim 6, wherein the ratio is about 1:5.

8. The process of claim 2, further comprising the step of carving the resin/sand mixture prior to heating.

9. The process of claim 2, further comprising the step of decorating the sand casting after it has cooled.

10. The process of claim 2, wherein step (b) comprises using a rolling pin on a flat bed.

11. The process of claim 2, wherein the microwavable mold is a multi-part microwavable vacuum mold.

12. The process of claim 11, wherein the non-toxic binding resin is diluted with water in a ratio of about 1:1.

13. A kit for making a sand casting comprising: sand; a non-toxic binding resin; and, a microwavable mold.

14. A kit for making a sand casting comprising: sand; a non-toxic binding resin; a rolling pin; microwavable flat bed; and adjustable retainers.

15. The kit of claim 13, wherein the non-toxic binding resin comprises a poly (vinyl acetate).

16. The kit of claim 14, wherein the non-toxic binding resin comprises a poly (vinyl acetate).

17. The kit of claim 13, further comprising carving tools.

18. The kit of claim 14, further comprising carving tools.

19. The kit of claim 13, further comprising decorating tools.

20. The kit of claim 14, further comprising decorating tools.

21. The kit of claim 13, for use in a process for casting sand, said process comprising the steps of:
(a) mixing the sand with the non-toxic binding resin to form a resin/sand mixture;
(b) casting the resin/sand mixture into a preferred form using the microwavable mold;
(c) heating the resin/sand mixture until a sand casting is set; and
(d) letting the sand casting cool.

22. The kit of claim 14, for use in a process for casting sand, said process comprising the steps of:
(a) mixing the sand with the non-toxic binding resin to form a resin/sand mixture;
(b) casting the resin/sand mixture into a preferred form using the rolling pin, microwavable flat bed, and adjustable retainers;
(c) heating the resin/sand mixture until a sand casting is set; and
(d) letting the sand casting cool.
